(19) United States
(12) Patent Application Publication
(10) Pub. No.: US 2020/0103732 A1
(43) Pub. Date: Apr. 2, 2020

(54) OPTICAL ELEMENT ADJUSTMENT MODULE AND PROJECTOR

(71) Applicant: Coretronic Corporation, Hsin-Chu (TW)

(72) Inventors: Yi-Chang Chen, Hsin-Chu (TW); Chien-Chung Liao, Hsin-Chu (TW)

(73) Assignee: Coretronic Corporation, Hsin-Chu (TW)

(21) Appl. No.: 16/575,406

(22) Filed: Sep. 19, 2019

(30) Foreign Application Priority Data
Sep. 28, 2018 (CN) 201811136883.3

(51) Int. Cl. G03B 21/14; G02B 7/182; G02B 7/00; G03B 33/12

(52) U.S. Cl. CPC G03B 21/145; G02B 7/1825; G03B 21/142; G03B 33/12; G02B 7/003

(57) ABSTRACT

An optical element adjustment module includes a mount comprising at least one first mount hole, at least one first fixing member, and at least one adjustment structure disposed on the mount and comprising an optical element, a supporting member, and a base. The optical element comprises a first surface and is held on the supporting member. The supporting member is fixed on the base, and the base includes a first base hole. The central axis of the first base hole is parallel to the first surface of the optical element. Each of the adjustment structures is rotated relative to the mount with respect to the first fixing member, so as to adjust the relative positions of the adjustment structure and the mount slightly as required.

### CROSS-REFERENCE TO RELATED APPLICATION

This application claims the priority benefit of China application serial no. 201811136883.3, filed on Sep. 28, 2018. The entirety of the above-mentioned patent application is hereby incorporated by reference herein and made a part of this specification.

### BACKGROUND OF THE INVENTION

### Field of the Invention

The invention relates to an adjustment module and a projector, and more particularly, to an optical element adjustment module and a projector.

### Description of Related Art

Generally, in order to optimize the brightness and/or color temperature of a light beam emitted from a device (such as a projector) comprising a light emitting module, the manufacturer needs to preset angles of various optical elements (such as a mirror or a lens) disposed in the device before the device is assembled and/or packed. However, how to adjust the angle of the optical element quickly, simply, and accurately is a subject to be explored by those skilled in the art.

The information disclosed in this “BACKGROUND OF THE INVENTION” section is only for enhancement of understanding of the background of the described technology and therefore it may contain information that does not form the prior art that is already known to a person of ordinary skill in the art. Further, the information disclosed in the “BACKGROUND OF THE INVENTION” section does not mean that one or more problems to be resolved by one or more embodiments of the invention were acknowledged by a person of ordinary skill in the art.

### SUMMARY OF THE INVENTION

The invention is directed towards an optical element adjustment module which may be used to quickly, simply, and accurately adjust the relative positions of an adjustment structure and a mount slightly as required.

The invention is directed towards a projector comprising the optical element adjustment module.

Other objects and advantages of the invention may be further understood by the technical features broadly embodied and described as follows.

To achieve one or a part of or all of the objects aforementioned or other objectives, an embodiment of the invention provides an optical element adjustment module. The optical element adjustment includes a mount, at least one adjustment structure, and at least one first fixing member. The mount includes at least one first mount hole. The at least one adjustment structure is detachably disposed on the mount. Each of the adjustment structures includes an optical element, a supporting member, and a base. The optical element includes a first surface. The optical element is held on the supporting member. The supporting member is fixed on the base, and the base includes a first base hole. The central axis of the first base hole is parallel to the first surface of the optical element. The first fixing member passes through the first mount hole of the mount and is connected into the first base hole of the base of the adjustment structure.

An embodiment of the invention provides a projector including a light source, the optical element adjustment module described-above, a light valve, and a projection lens. The light source is used to emit a first light beam. The optical element adjustment module is disposed on a transmission path of the first light beam, and the first light beam is adjusted to be a second light beam after passing through the optical element of the optical element adjustment module. The light valve is disposed on a transmission path of the second light beam, and the second light beam is converted into an image light beam after passing through the light valve. The projection lens is disposed on a transmission path of the image light beam and is configured to project the image light beam.

Based on the above, the first fixing members of the optical element adjustment module of the invention pass through the first mount hole and are connected into the first base hole, and the adjustment structure is stably rotated relative to the mount with respect to the first fixing member, such that the adjustment structure may be quickly and simply rotated. When the first fixing member is loosened in the first base hole, the adjustment structure is rotatable relative to the mount. When the first fixing member is tightened in the first base hole, the adjustment structure is perpendicularly fixed on the mount. In addition, since the central axis of the first base hole is parallel to the first surface of the optical element, the first surface of the optical element is rotated by rotating the adjustment structure, so as to accurately rotate the first surface of the optical element to a desired position.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a perspective view of an optical element adjustment module according to an embodiment of the invention.

FIG. 2 is a perspective view of FIG. 1 from another viewing angle.

FIG. 3 is a top view of the optical element adjustment module of FIG. 1.

FIG. 4 is an exploded view of the optical element adjustment module of FIG. 1.

FIG. 5 is an exploded view of FIG. 4 from another viewing angle.

FIG. 6 is a cross section view of FIG. 2.

FIG. 7 is a schematic of a projector according to an embodiment of the invention.

FIG. 8 is a schematic of a projector according to another embodiment of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

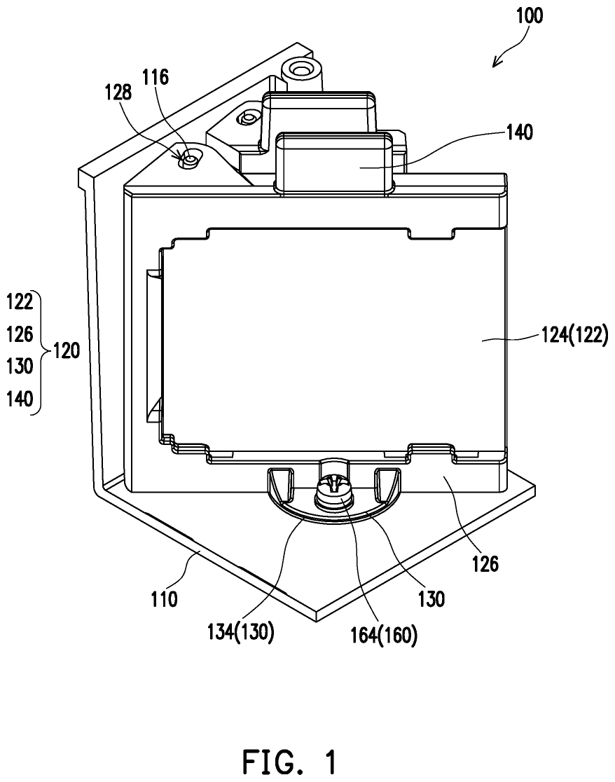

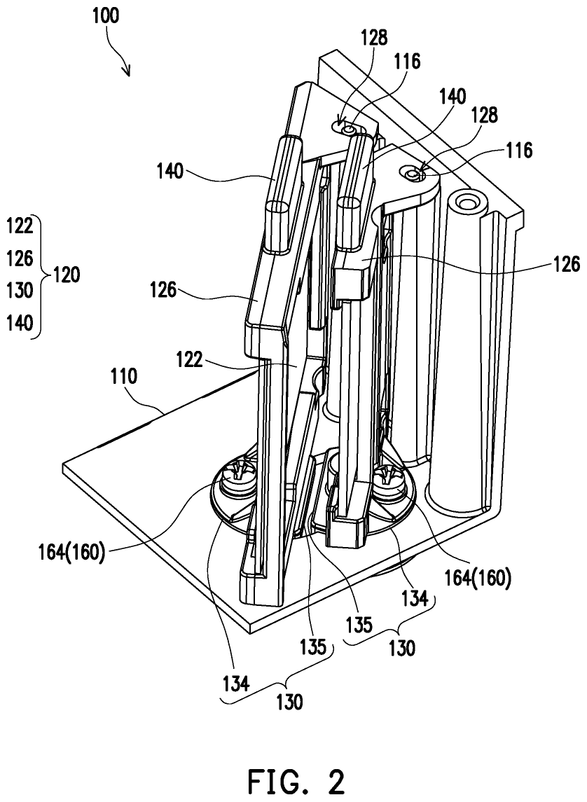

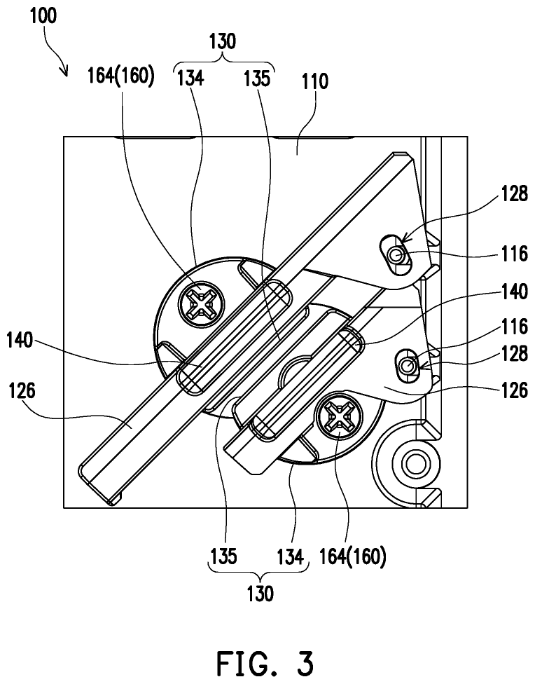

FIG. 1 is a perspective view of an optical element adjustment module according to an embodiment of the invention. FIG. 2 is a perspective view of FIG. 1 from another viewing angle. FIG. 3 is a top view of the optical element adjustment module of FIG. 1. Referring to FIG. 1 to FIG. 3, an optical element adjustment module 100 of the embodiment may be applied to a display device such as a projector, and the angle of the optical element adjustment module 100 may be adjusted, so that the brightness and/or the color temperature of a light beam emitted from a device (such as a projector) comprising the optical element adjustment module 100 may be optimized. Of course, the optical element adjustment module 100 may also be applied to other devices, and is not limited to the above. The detailed structure of the optical element adjustment module 100 is described in detail below.

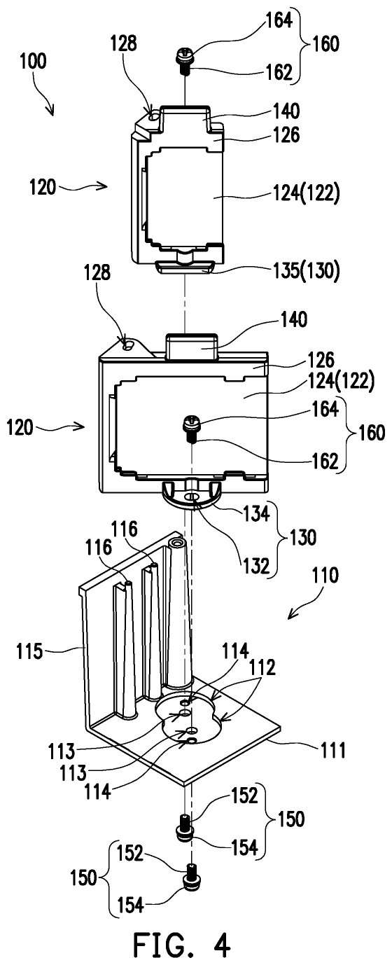

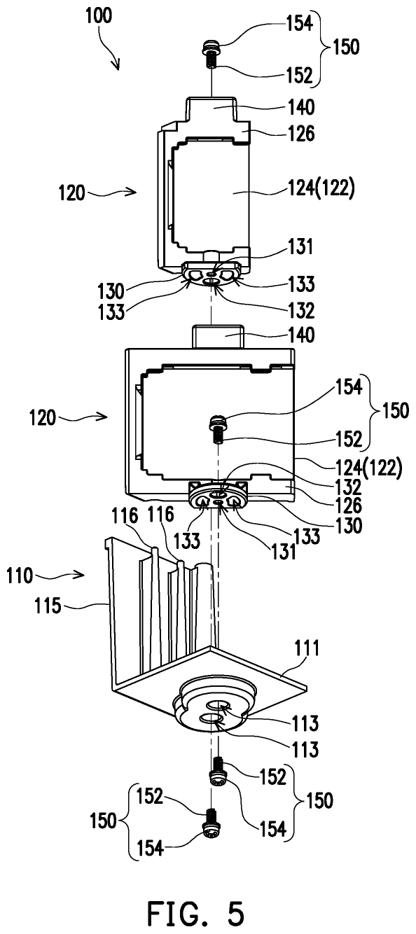

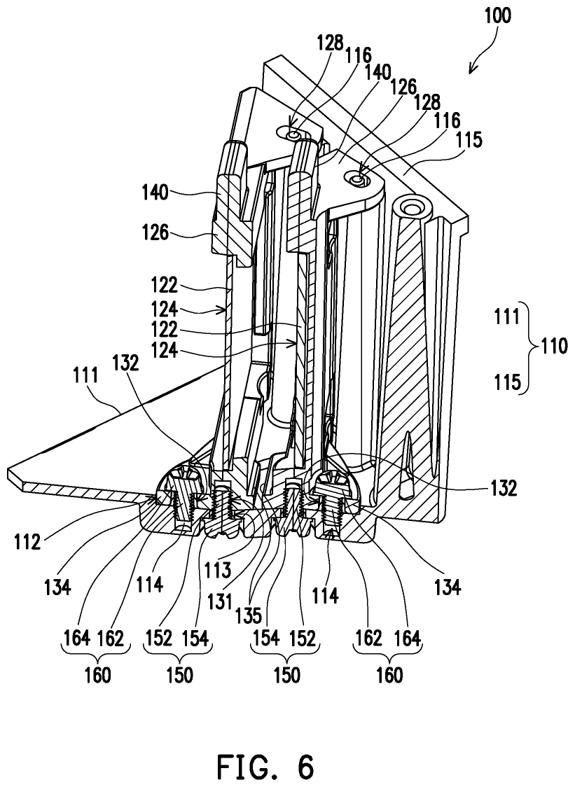

FIG. 4 is an exploded view of the optical element adjustment module of FIG. 1. FIG. 5 is an exploded view of FIG. 4 from another viewing angle. FIG. 6 is a cross section view of FIG. 2. Referring to FIG. 1 to FIG. 6, the optical element adjustment module 100 of the embodiment includes a mount 110, at least one adjustment structure 120, and at least one first fixing member 150. As shown in FIG. 4, in the embodiment, at least one first mount hole 113 includes two first mount holes 113, the at least one adjustment structure 120 includes two adjustment structures 120, and the at least one first fixing member 150 includes two first fixing members 150. Certainly, the numbers of the first mount holes 113, the adjustment structures 120, or the first fixing members 150 are not limited thereto, and the number “two” may be referred to the number of elements or element combinations. For example, “two first mount holes 113” may mean “two single first mount holes 113”, and “two adjustment structures 120” may mean “two sets of adjustment structures 120”. However, the invention is not limited thereto. In other embodiments, the numbers of the first mount holes 113, the adjustment structures 120, and the first fixing members 150 may respectively be single or plural.

In the embodiment, the first mount holes 113 are formed on a substrate 111 of the mount 110, and the adjustment structures 120 are detachably disposed on the substrate 111 of the mount 110. In the embodiment, the adjustment structures 120 include optical elements 122, a supporting member 126, and a base 130. In the embodiment, the optical elements 122 are, for example, reflectors or beam splitters, but the type of the optical elements 122 is not limited thereto, and the optical elements 122 may also be lenses. The optical elements 122 include a first surface 124.

In the embodiment, the optical elements 122 are held on the supporting members 126 and the supporting members 126 are fixed on the bases 130. The supporting members 126 and the bases 130 may be integrated, but the invention is not limited thereto. The supporting members 126 are, for example, frames for the optical elements 122, and the supporting members 126 may be in contact with a plurality of edges of the optical elements 122, so as to securely fix and maintain the position of the optical elements 122. In the embodiment, the supporting members 126, for example, fix and abut three edges of the optical elements 122. However, in other embodiments, the supporting members 126 may also fix and abut four edges or two edges of the optical elements 122, and the invention is not limited thereto.

As may be seen from FIG. 6, in the embodiment, the bases 130 include first base holes 131. The central axis of the first base hole 131 is parallel to the first surfaces 124 of the optical elements 122. More specifically, it may be seen from the cross section of FIG. 6 that the axis of the first fixing members 150 is parallel to the first surfaces 124 of the optical elements 122. In addition, the first base holes 131 of the bases 130 are aligned with the first mount holes 113 of the mount 110.

Each of the first fixing members 150 passes through one of the first mount holes 113 and is connected into the corresponding first base hole 131. In the embodiment, the first fixing members 150 are, for example, screws. The first fixing members 150 include connecting portions 152 and caps 154, the connecting portions 152 have an external thread, and the first base holes 131 have an internal thread. The inner diameter of the first mount holes 113 is greater than the inner diameter of the first base holes 131, such that the connecting portions 152 of the first fixing members 150 may pass through the first mount holes 113. In addition, the size of the caps 154 of the first fixing members 150 is greater than the aperture of the first mount holes 113, such that the caps 154 of the first fixing members 150 are pressed against the mount 110. Certainly, the form of the first fixing members 150 is not limited thereto.

In the embodiment, by loosening the connecting portions 152 of the first fixing members 150 in the first base holes 131, the bases 130 of the adjustment structures 120 may be rotated relative to the mount 110, such that the adjustment structures 120 are stably rotated relative to the mount 110 with respect to the first fixing members 150. Alternatively, by tightening the connecting portions 152 of the first fixing members 150 in the first base holes 131, the bases 130 of the adjustment structures 120 may be fixed to the mount 110, thereby quickly and simply adjusting the relative positions of the adjustment structures 120 and the mount 110 slightly as required. Moreover, since the central axis (overlapped with the axis of the first fixing members 150) of the first base holes 131 is parallel to the first surfaces 124 of the optical elements 122, the first surfaces 124 of the optical elements 122 are rotated by rotating the adjustment structures 120. Therefore, the first surfaces 124 of the optical elements 122 may be accurately rotated to a desired position.

In the embodiment, each of the adjustment structures 120 may include an adjustment handle 140 disposed on a corresponding supporting member 126 and away from the bases 130. The adjustment handles 140 may be held by a user, or may be held by a user via a tool, so as to more simply adjust the angle of the adjustment structures 120. In the embodiment, the thickness of the adjustment handles 140 is less than the thickness of the supporting members 126, and the thickness of the adjustment handles 140 is greater than or equal to 2 mm. Such size a range allows the user to hold the adjustment handles 140 or hold the adjustment handles 140 via a tool more conveniently and easily, and may allow the user to observe the positions of the supporting members 126 during rotation. Certainly, the position and size of the adjustment handles 140 are not limited thereto.

In addition, as shown in FIG. 4, in the embodiment, the outer contour of each of the bases 130 may at least partially include an arc-shaped outer edge 134, and the central axis (not shown in FIG. 4) of the first base holes 131 passes through the center of the circular contour extended by the arc-shaped outer edges 134. The substrate 111 of the mount 110 may include grooves 112. A portion of the inner contour of the grooves 112 matches the contour of the arc-shaped outer edges 134 to accommodate and position the base 130, so as to make the assembly and positioning process more conventional. In the embodiment, the ratio of the diameter of the arc-shaped outer edges 134 of the bases 130 to the height of the supporting members 126 (or the height of the optical elements 122) is between about 1/10 and 1/3, such that the bases 130 may still provide stable support in a limited space.

In the embodiment, friction is provided by the contact between the upper surface of the grooves 112 of the mount 110 and the lower surface of the bases 130. Thus, when the operator finishes manually adjusting the angle of the first surfaces 124 of the optical elements 122, the first surfaces 124 of the optical elements 122 may be maintained on a desired position.

In addition, it may be seen in FIG. 5 that in the embodiment, the base 130 of each of the adjustment structures 120 may include at least one concave hole 133 recessed from the surface of the base 130 facing the mount 110. In the embodiment, the concave holes 133 may be used to achieve a larger bottom area or a smaller bottom area of the bases 130. Specifically, in case more and larger concave holes 133 are disposed, the bases 130 may have a smaller bottom area. In other words, the contact area between the lower surface of the bases 130 and the upper surface of the grooves 112 of the mount 110 is smaller, and therefore the friction between the bases 130 and the mount 110 is reduced. Conversely, in case less and smaller concave holes 133 are disposed, the friction between the bases 130 and the mount 110 is increased. The designer may increase or decrease the number and size of the concave holes 133 of the base 130 as needed, thereby increasing or decreasing the friction between the bases 130 and the mount 110, so as to maintain a balance between the force needed to rotate the adjustment structures 120 and the secureness of the adjustment structures 120 relative to the mount 110.

It should be noted that, in FIG. 4 and FIG. 6, in the embodiment, the optical element adjustment module 100 may further include at least one second fixing member 160, the mount 110 includes at least one second mount hole 114, and the base 130 of each of the adjustment structures 120 includes a second base hole 132. The size of the second base holes 132 is greater than the size of the second mount holes 114, and the second base holes 132 are aligned with the second mount holes 114. For example, the second mount holes 114 are circular holes, and the second base holes 132 are arc-shaped long round holes aligned with the circular holes. Each of the second fixing members 160 passes through one of the second base holes 132 and is connected into the second mount hole 114. In the embodiment, the second fixing members 160 are further used to stably secure the adjustment structures 120 to the mount 110.

In the embodiment, the second fixing members 160 are, for example, screws, and each of the second fixing members 160 includes a connecting portion 162 and a cap 164 connected with each other. The connecting portions 162 have an external thread and the second mount holes 114 have an internal thread. For example, the size of the cap 164 is greater than the aperture of the second base hole 132, and the aperture of the second base hole 132 is greater than the outer diameter of the connecting portion 162. The connecting portions 162 pass through the second base holes 132 and are threaded into the second mount holes 114, and the caps 164 are pressed against the bases 130.

It is to be noted that since the manufacturer may assemble the bases 130 to the mount 110, the first fixing members 150 is used to fix the bases 130 to the mount 110. At this point, the adjustment structures 120 may be rotated slightly with respect to the first fixing members 150. In addition, the second fixing members 160 are used to stably fix the bases 130 on the mount 110, and thus the undesirable movement of the bases 130 relative to the mount 110 is further avoided. The second base holes 132 are required to be able to be aligned with the second mount holes 114 even though the adjustment structures 120 are slightly rotated, such that the adjustment structures 120 may be able to be rotated to various different positions relative to the mount 110 and be able to be fixed at that position. As may be seen in FIG. 4 and FIG. 5, in the embodiment, each of the second base holes 132 is a non-circular hole. For example, the second base holes 132 may be arc-shaped long round holes, such as elliptical holes. In other embodiments, the second base holes 132 may also be curved grooves. Certainly, the form and shape of the second base holes 132 are not limited thereto. The non-circular shape of the second base holes 132 allows the second fixing members 160 to be able to pass through the second base holes 132 and be able to be connected into the second mount holes 114, even though the adjustment structures 120 are rotated.

In other embodiments, the second base holes 132 may also be circular holes, the size of the caps 164 is required to be greater than the aperture of the second base holes 132, and the aperture of the second base holes 132 is required to be greater than the outer diameter of the connecting portions 162. The portion of the second base holes 132 with an aperture greater than the outer diameter of the connecting portions 162 acts to provide a rotation range for the adjustment structures 120.

In addition, as shown in FIG. 3, each of the bases 130 includes a straight outer edge 135 connected to an arc-shaped outer edge 134, and two straight outer edges 135 of two bases 130 are adjacent to each other and spaced apart from each other, such that the two adjustment structures may be rotated independently relative to the mount. In such a configuration, the straight outer edge 135 of one of the bases 130 acts to limit the rotation range of the other base 130. In the embodiment, the rotation range of the adjustment structures 120 is greater than 0 and less than or equal to 5 degrees, but is not limited thereto. It is worth mentioning that in the embodiment, the rotation range of the adjustment structures 120 may be limited by another adjustment structure 120 due to the interference there-between. Alternatively, the rotation range of the adjustment structures 120 may be limited due to the size of the second base holes 132.

Furthermore, as seen in FIG. 4, in the embodiment, the mount 110 includes a side wall 115 extending upward from the substrate 111 and at least one indicator column 116 extending from the side wall 115. The supporting member 126 of each of the adjustment structures 120 includes a perforation 128, and each of the indicator columns 116 is disposed in the perforation 128 to indicate the relative positions of the supporting member 126 and the mount 110. For example, the supporting members 126 may be provided with a scale next to the perforations 128, and the manufacturer may read the relative positions of the indicator columns 116 in the perforations 128 and may thereby determine if the positions of the adjustment structures 120 relative to mount 110 are appropriate. In the embodiment, the aperture of the perforations 128 is greater than 2 mm, the diameter of the indicator columns 116 is smaller than the aperture of the perforations 128 and greater than 1.5 mm. The aperture of the perforations 128 and/or the diameter of the indicator columns 116 are not limited thereto.

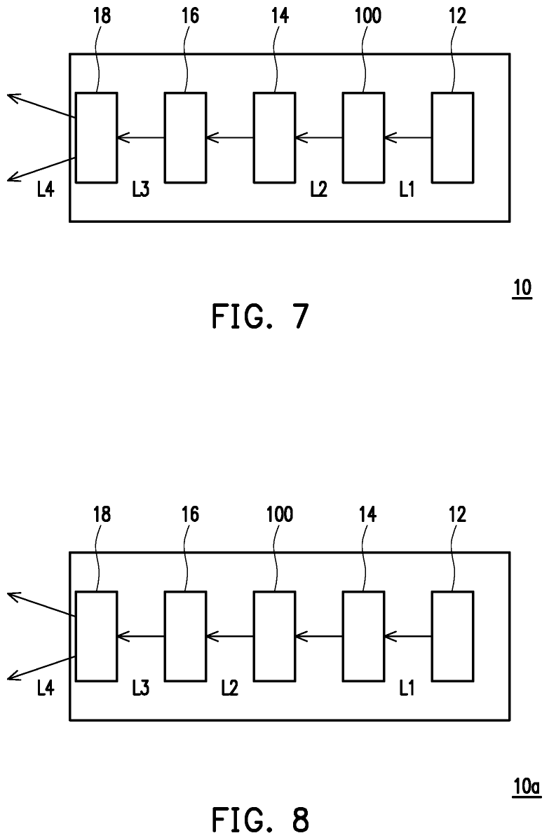

FIG. 7 is a schematic of a projector according to an embodiment of the invention. It is to be noted that in FIG. 7, simple optical transmission paths and elements in a projector 10 are merely schematically showed, and the form of the projector 10 is not limited thereto. Referring to FIG. 7, the projector 10 of the embodiment includes a light source 12, the optical element adjustment module 100 described-above, a light valve 16, and a projection lens 18.

In the embodiment, the light source 12 is used to emit a first light beam L1. In the embodiment, the light source 12 is exemplified by a laser light source 12. For example, the light source 12 may include a plurality of laser diodes (not shown) arranged in an array, but the invention is not limited thereto.

The optical element adjustment module 100 is disposed on the transmission path of the first light beam L1, and the first light beam L1 passes through the optical elements 122 of the optical element adjustment module 100. Alternatively, the first light beam L1 may be adjusted to be a second light beam L2 after passing through the optical elements 122 (FIG. 1) of the optical element adjustment module 100. In the embodiment, the optical elements 122 of the optical element adjustment module 100 is, for example, a reflector or a beam splitter. In the case of a reflector, the transmission path of the light beam may be changed. In the case of a beam splitter, the beam splitter may be a partially-transmissive and partially-reflective element, a dichroic element, a polarization splitting element, or various other elements that may divide a light beam. Specifically, in the embodiment, the optical elements 122 may, for example, allow a blue light beam to pass through and reflect light beams of other colors (such as red, green, or yellow). In such a configuration, the second light beam L2 is a blue light beam. However, the form and the type of the optical elements 122 of the optical element adjustment module 100 are not limited thereto. In the embodiment, the projector 10 further includes a light-homogenizing element 14 disposed on the transmission path of the second light beam L2. In the embodiment, the light-homogenizing element 14 includes an integrated rod, and the light-homogenizing element 14 may be used to homogenize the light beam passing there-through, but the invention is not limited thereto.

Next, the light valve 16 is disposed on the transmission path of the second light beam L2. The second light beam L2 passing from the light-homogenizing element 14 may irradiate onto the light valve 16, and may be converted into an image light beam L3. In the embodiment, the light valve 16 is, for example, a digital micro-mirror device (DMD) or a liquid-crystal-on-silicon (LCOS) panel. However, in other embodiments, the light valve 16 may also be a transmissive liquid crystal panel or other beam modulators. The projection lens 18 is disposed on the transmission path of the image light beam L3 and is configured to project the image light beam L3 to form an image on a screen.

FIG. 8 is a schematic of a projector according to another embodiment of the invention. Referring to FIG. 8, the main difference between a projector 10a of FIG. 8 and the projector 10 of FIG. 7 is that, in FIG. 8, the light-homogenizing element 14 is disposed on the transmission path of the first light beam L1, and the first light beam L1 is, for example, an illumination light beam. The first light beam L1 passing from the light-homogenizing element 14 may pass through the optical elements 122 of the optical element adjustment module 100.

In the projectors 10 and 10a described-above, with the configuration of the optical element adjustment module 100, the manufacturer may adjust the angle of the optical elements 122 quickly, simply, and accurately, and thus the brightness and/or color temperature of the light beam emitted from the projector 10 may also be adjusted as required, so as to provide a good optical quality.

Based on the above, the first fixing members of the optical element adjustment module of the invention pass through the first mount holes and are connected into the first base holes, and the adjustment structures are stably rotated relative to the mount with respect to the first fixing members, such that the adjustment structures may be quickly and simply rotated. In addition, since the central axis of the first base hole is parallel to the first surface of the optical element, the first surface of the optical element is rotated by rotating the adjustment structures, so as to accurately rotate the first surface of the optical element to a desired position.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An optical element adjustment module, comprising:
a mount comprising at least one first mount hole;
at least one adjustment structure disposed on the mount, wherein the at least one adjustment structure comprises:
an optical element comprising a first surface;
a supporting member, wherein the optical element is held on the supporting member; and
a base, wherein the supporting member is fixed on the base, and the base comprises:
a first base hole, wherein a central axis of the first base hole is parallel to the first surface of the optical element; and
at least one first fixing member passing through the at least one first mount hole of the mount and connected into the first base hole of the base of the at least one adjustment structure.

2. The optical element adjustment module of claim 1, further comprising;
at least one second fixing member;
wherein the mount further comprises at least one second mount hole, and the base of the at least one adjustment structure further comprises a second base hole,
wherein the at least one second fixing member passes through the second base hole of the base and is connected into the at least one second mount hole of the mount, and a size of the second base hole of the base is greater than a size of the at least one second mount hole of the mount.

3. The optical element adjustment module of claim 2, wherein the at least one second fixing member comprises a connecting portion and a cap connected with each other, a size of the cap is greater than an aperture of the second base hole, the connecting portion passes through the second base hole of the base, and the cap is pressed against the base.

4. The optical element adjustment module of claim 2, wherein the second base hole of the base is a non-circular hole.

5. The optical element adjustment module of claim 1, wherein the base comprises at least one concave hole recessed from a surface of the base facing the mount, so as to adjust a friction between the at least one adjustment structure and the mount.

6. The optical element adjustment module of claim 1, wherein the mount comprises at least one indicator column, the supporting member comprises a perforation, and the at least one indicator column is disposed in the perforation of the supporting member, so as to indicate relative positions of the supporting member and the mount.

7. The optical element adjustment module of claim 1, wherein the at least one adjustment structure comprises an adjustment handle disposed on the supporting member and away from the base.

8. The optical element adjustment module of claim 1, wherein an outer contour of the base of the at least one adjustment structure at least partially comprises an arc-shaped outer edge, and the central axis of the first base hole passes through a center of a circular contour extended by the arc-shaped outer edge.

9. The optical element adjustment module of claim 1, wherein the at least one first mount hole comprises two first mount holes, and the at least one adjustment structure comprises two adjustment structures, wherein each of the two adjustment structures comprises the base,
the at least one first fixing member comprises two first fixing members, each of the two first fixing members respectively passes through the two first mount holes and are respectively connected into the two adjustment structures, wherein outer contours of the two bases of the two adjustment structures each comprise an arc-shaped outer edge and a straight outer edge, the arc-shaped outer edge and the straight outer edge are connected with each other, and the two straight outer edges of the two bases are adjacent to each other and spaced apart from each other such that the two adjustment structures are configured to rotate independently relative to the mount.

10. A projector, comprising;
a light source emitting a first light beam;
an optical element adjustment module;
a light valve; and
a projection lens,
wherein the optical element adjustment module comprises:
a mount comprising at least one first mount hole;
at least one adjustment structure disposed on the mount, wherein the at least one adjustment structure comprises:
an optical element comprising a first surface;
a supporting member, wherein the optical element is held on the supporting member; and
a base, wherein the supporting member is fixed on the base, and the base comprises a first base hole, wherein a central axis of the first base hole is parallel to the first surface of the optical element; and
at least one first fixing member passing through the at least one first mount hole of the mount and connected into the first base hole of the base of the at least one adjustment structure,
wherein the optical element adjustment module is disposed on a transmission path of the first light beam, and the first light beam is adjusted to be a second light beam after passing through the optical element of the optical element adjustment module,
the light valve is disposed on a transmission path of the second light beam, and the second light beam is converted into an image light beam after passing through the light valve; and
the projection lens is disposed on a transmission path of the image light beam and configured to project the image light beam.

11. The projector of claim 10, further comprising;
a light-homogenizing element disposed on the transmission path of the second light beam, wherein the second light beam passes through the light valve after passing through the light-homogenizing element.

12. The projector of claim 10, further comprising;
a light-homogenizing element disposed on the transmission path of the first light beam, wherein the first light beam passes through the optical element of the optical element adjustment module after passing through the light-homogenizing element.
